(19) United States
(12) Patent Application Publication
(10) Pub. No.: US 2016/0082475 A1
(43) Pub. Date: Mar. 24, 2016

(54) VIBRATION GENERATING DEVICE

(71) Applicant: SAMSUNG ELECTRO-MECHANICS CO., LTD., Suwon-Si (KR)

(72) Inventor: Jae Kyung KIM, Suwon-Si (KR)

(73) Assignee: SAMSUNG ELECTRO-MECHANICS CO., LTD., Suwon-Si (KR)

(21) Appl. No.: 14/645,698

(22) Filed: Mar. 12, 2015

(30) Foreign Application Priority Data
Sep. 18, 2014 (KR) 10-2014-0124269

(51) Int. Cl. B06B 1/06; B06B 1/02

(52) U.S. Cl. CPC B06B 1/0603; B06B 1/0207

(57) ABSTRACT

There is provided a vibration generating device including: a housing having an internal space; a vibrating member provided in the internal space to vibrate; a piezoelectric element coupled to one surface of the vibrating member; and a board which is provided to enclose a portion of outer surfaces of the housing, on which at least one driving element is mounted in order to supply a voltage to the piezoelectric element, and of which one side is disposed in the internal space to be connected to the piezoelectric element.

### CROSS-REFERENCE TO RELATED APPLICATION

This application claims the priority and benefit of Korean Patent Application No. 10-2014-0124269 filed on Sep. 18, 2014, with the Korean Intellectual Property Office, the disclosure of which is incorporated herein by reference.

### BACKGROUND

The present disclosure relates to a vibration generating device.

Vibration generating devices are commonly mounted in portable electronic devices such as mobile phones, and may be used for a variety of purposes.

Here, in accordance with the trend for increased functionality in portable electronic devices, a variety of electronic components have been mounted in portable electronic devices.

Therefore, the miniaturization of vibration generating devices mounted in portable electronic devices has been demanded.

Meanwhile, vibration generating devices require a driving element for the application of a voltage thereto. According to the related art, a separate circuit has been connected to the vibration generating device to apply the voltage to the vibration generating device.

Therefore, a problem that an overall volume for an operation of the vibration generating device has increased.

In addition, there has been a problem that a resonant frequency may be changed in the case of decreasing a size of the vibration generating device.

Therefore, research into a vibration generating device capable of significantly decreasing a volume occupied by a circuit for driving a vibration generating device to decrease the size thereof has been urgently demanded.

### SUMMARY

An aspect of the present disclosure may provide a vibration generating device in which a size of a driving circuit part is significantly reduced.

An aspect of the present disclosure may also provide a vibration generating device capable of having a decreased size while maintaining a resonant frequency.

According to an aspect of the present disclosure, a vibration generating device may include: a housing having an internal space; a vibrating member provided in the internal space to vibrate; a piezoelectric element coupled to one surface of the vibrating member; and a board which is provided to enclose a portion of outer surfaces of the housing, on which at least one driving element is mounted in order to supply a voltage to the piezoelectric element, and of which one side is disposed in the internal space to be connected to the piezoelectric element.

Therefore, a driving circuit for driving the piezoelectric element may be formed integrally with the housing rather than being provided as a separate element, whereby an overall size of the vibration generating device may be significantly decreased.

In addition, the vibrating member may be bent in the vibration generating device at least two or more times.

Therefore, even when an overall size of the vibration generating device is decreased, an entire length of the vibrating member may be maintained to secure a resonant frequency.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view of a vibration generating device, according to an exemplary embodiment of the present disclosure;

FIG. 2 is an exploded perspective view of the vibration generating device from which a protective cap is separated, according to an exemplary embodiment of the present disclosure;

FIG. 3 is an exploded perspective view of the vibration generating device from which a second board is separated, according to an exemplary embodiment of the present disclosure;

FIG. 4 is a schematic cross-sectional view of the vibration generating device according to an exemplary embodiment of the present disclosure;

FIG. 5 is a perspective view of a vibrating member according to an exemplary embodiment of the present disclosure;

FIG. 6 is a bottom perspective view of the vibrating member according to an exemplary embodiment of the present disclosure;

FIG. 7 is a cross-sectional view taken along line A-A′ of FIG. 5;

FIG. 8 is a perspective view of a weight body according to an exemplary embodiment of the present disclosure;

FIG. 9 is a plan view of the coupling of the vibrating member and the weight body, according to an exemplary embodiment of the present disclosure; and

FIG. 10 is a perspective view of the second board according to an exemplary embodiment of the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

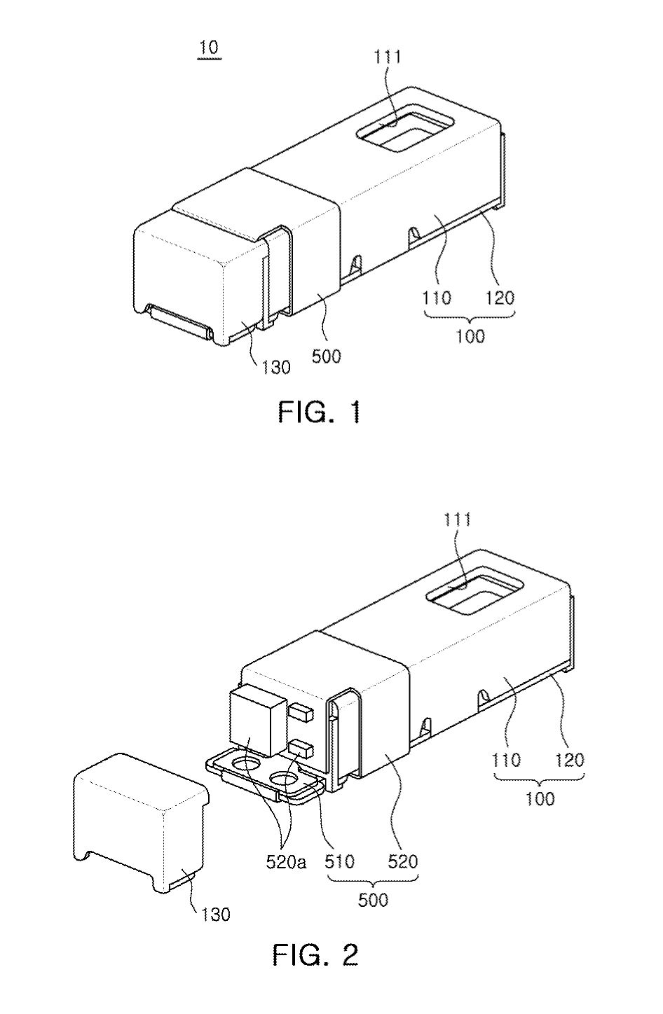

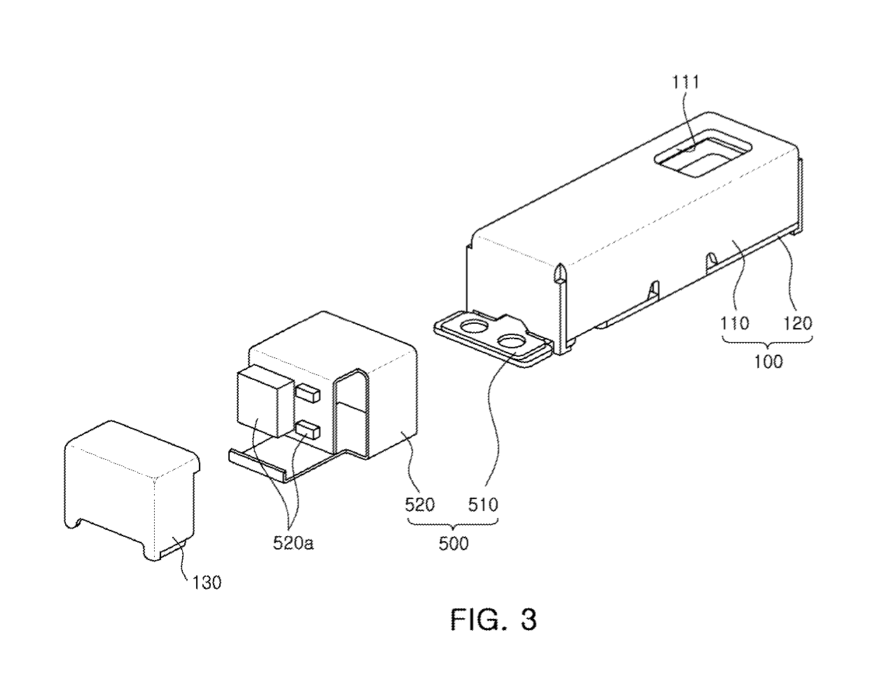

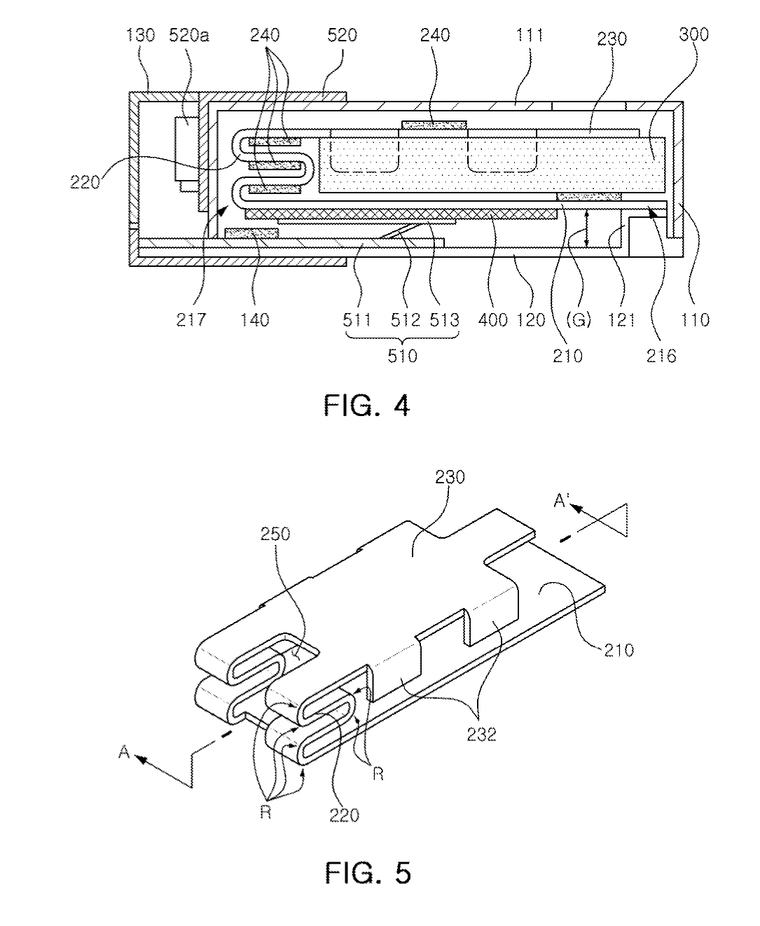

FIG. 1 is a perspective view of a vibration generating device according to an exemplary embodiment of the present disclosure; FIG. 2 is a perspective view of the vibration generating device from which a protective cap is separated, according to an exemplary embodiment of the present disclosure; FIG. 3 is a perspective view of the vibration generating device from which a second board is separated, according to an exemplary embodiment of the present disclosure; and FIG. 4 is a schematic cross-sectional view of the vibration generating device according to an exemplary embodiment of the present disclosure.

Referring to FIGS. 1 to 4, a vibration generating device 10 according to an exemplary embodiment of the present disclosure may include a housing 100, a vibrating member 200, a weight body 300, a piezoelectric element 400, and a board 500.

The housing 100, which forms the exterior appearance of the generation generating device 10, may include an upper case 110 and a lower case 120 coupled to the upper case 110 to form an internal space. A vibrating member 200, a weight body 300, and a piezoelectric element 400 to be described below may be disposed in the internal space formed by the upper case 110 and the lower case 120, and a portion of the board 500 may also be disposed in the internal space.

Here, the upper case 110 and the lower case 120 may be coupled to each other by various methods such as a welding method, a bonding method using an adhesive, a hooking method, and the like.

The lower case 120 may be provided with a support member 121 securing a space in which the vibrating member 200 may vibrate, wherein the support member 121 may protrude from one side of the lower case 120 toward the internal space.

The support member 121 may be manufactured by bending one side of the lower case 120 or be manufactured simultaneously with the lower case 120 at the time of manufacturing the lower case 120.

The support member 121 may be formed by bending the lower case 120 or coupling a separate support member (not shown) to the lower case 120. Here, as a method of coupling the separate support member to the lower case 120, various methods such as a welding method, a bonding method using an adhesive, and the like, may be used.

One end of the vibrating member 200 may be fixed to the support member 121, and the vibrating member 200 may vibrate in a state in which one end thereof is fixed to the support member 121.

That is, the vibrating member 200 may be basically provided in a cantilever scheme, such that a free end thereof may vibrate.

A space in which the vibrating member 200 may vibrate, that is, an air gap G may be provided between the vibrating member 200 and the lower case 120 by the support member 121 protruding from the lower case 120.

In addition, the lower case 120 may have one side protruding outwardly of the upper case, and have the board 500 provided on an upper surface thereof. The board 500, which is a component of a driving circuit, may have a driving element 520a mounted thereon in order to apply a voltage to the piezoelectric element 400 of the vibration generating device. A detailed description for the board 500 will be provided below.

The upper case 110 may have a frequency adjusting hole 111 formed therein so that a resonant frequency of the vibration generating device 10 may be adjusted after the vibration generating device 10 is manufactured.

The frequency adjusting hole 111 may be formed by opening one side of the upper case 110 facing the weight body 300, and be provided on the upper case 110 to be biased toward a fixed end of the vibrating member 200.

Therefore, a manufacturer may couple an additional weight member (not shown) to the weight body 300 through the frequency adjusting hole 111, if necessary, even after the vibration generating device 10 is manufactured.

That is, since the resonant frequency of the vibration generating device 10 may be varied by amass of the weight body 300, the manufacturer may adjust amass of the additional weight member to set a desired resonant frequency.

Meanwhile, a protective cap 130 may be coupled to the housing 100. Here, the protective cap 130 may be provided in order to protect the driving element 520a mounted on the board 500 and be provided to cover one side of the housing 100 at which the board 500, more specifically, a second board 520 is provided.

That is, the board 500 may be coupled to outer surfaces of the housing 100, and may have at least one driving element 520a mounted thereon in order to drive the vibration generating device 10.

Here, the driving element 520a may be exposed to the outside. Therefore, there may be a risk that the driving element 520a will be damaged due to external impact or foreign materials will be introduced into the driving element 520a.

That is, the protective cap 130 may be provided on the housing 100 to enclose an outer surface of the driving element 520a to protect the driving element 520a.

The housing 100 may be provided with a stopper 140 preventing collision between the housing 100 and the vibrating member 200 and adjusting displacement of the vibrating member 200.

Here, the stopper 140 may contact the vibrating member 200 at the time of driving the vibration generating device 10.

That is, in the case in which the vibration generating device 10 is driven, since the vibrating member 200 vibrates within the housing 100, the vibrating member 200 may collide with an inner surface of the housing 100. In the case in which the vibrating member 200 collides with the housing 100, there may be a risk that the vibrating member 200 will be damaged.

Therefore, the stopper 140 may be provided in the housing 100 to prevent the collision between the vibrating member 200 and the housing 100. In addition, the stopper 140 may adjust displacement by which the vibrating member 200 may vibrate downwardly.

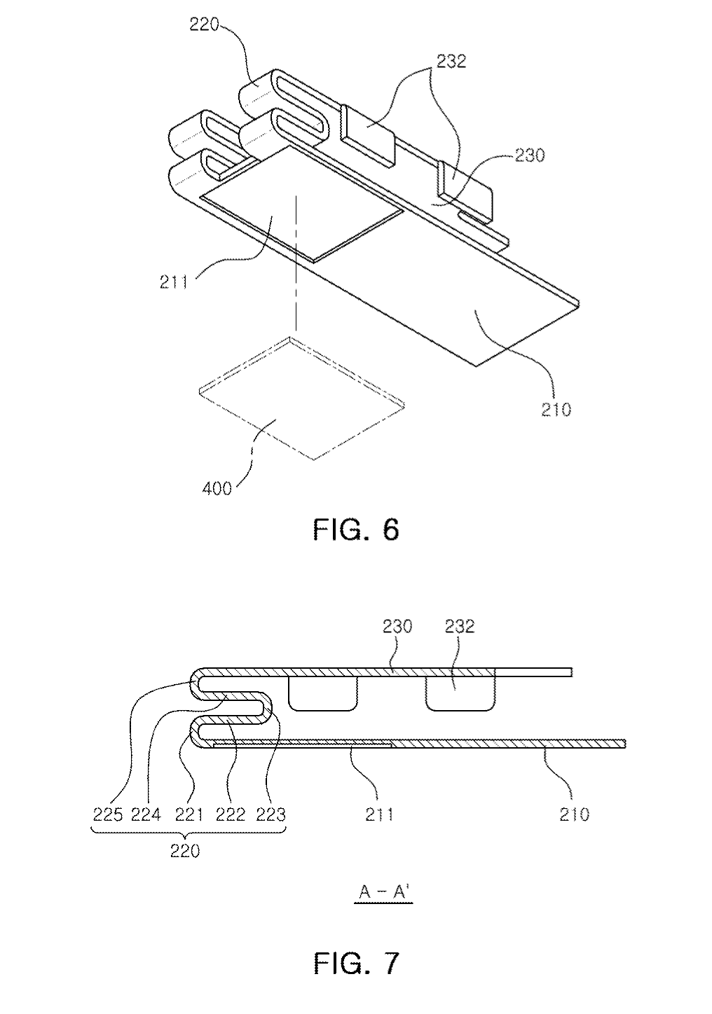

FIG. 4 is a schematic cross-sectional view of the vibration generating device according to an exemplary embodiment of the present disclosure; FIG. 5 is a perspective view of a vibrating member according to an exemplary embodiment of the present disclosure; FIG. 6 is a bottom perspective view of the vibrating member according to an exemplary embodiment of the present disclosure; and FIG. 7 is a cross-sectional view taken along line A-A′ of FIG. 5.

Referring to FIGS. 4 through 7, the vibrating member 200 may have one end that is fixed to the internal space of the housing 100 and the other end that may vibrate.

That is, the vibrating member 200 may include a first member 210 having one end which is fixed to the housing 100 to be a fixed end and the other end which is a free end, a second member 220 extended from the other end of the first member 210 in a direction upward from the first member 210, and a third member 230 extended from an end of the second member 220 toward one end of the first member 210, wherein the first to third members 210 to 230 may be provided with at least one damper 240 preventing collision therebetween.

Here, terms with respect to directions will be defined. An upper surface of a member refers to one surface of the member facing the upper case 110, and a lower surface of the member refers to one surface of the member facing the lower case 120.

In addition, in the present specification, it is to be noted that terms “upper side”, “lower side”, “side surface”, and the like, are represented based on the accompanying drawings and may be differently represented when directions of corresponding targets are changed.

The first member 210 may have one end fixed to the support member 121. That is, one end of the first member 210 may be a fixed end 216 fixed to the support member 121, and the other end thereof may be a free end 217.

Here, the first member 210 may be fixed to the support member 121 by a method such as a welding method, a bonding method using an adhesive, a screwing method, or the like.

The air gap G may be formed between the first member 210 and the lower case 120.

Meanwhile, the first member 210 may be provided with at least one piezoelectric element 400 vibrating the vibrating member 200 by an electrical signal.

Here, the piezoelectric element 400 may be formed of polymer or lead zirconate titanate (PZT).

However, the present disclosure is not necessarily limited thereto. That is, the piezoelectric element 400 may be formed of various materials as long as it may vibrate the vibrating member 200.

In addition, one surface of the first member 210 may be provided with a coupling groove 211 on and to which the piezoelectric element 400 may be seated and coupled, wherein the coupling groove 211 may be recessed from one surface of the first member 210 to correspond to an appearance of the piezoelectric element 400.

That is, the piezoelectric element 400 may be seated on and coupled to the coupling groove 211 to thereby be more firmly coupled to the first member 210.

The second member 220 may be bent at least two or more times and extended from the other end of the first member 210 in the direction upward from the first member 210. Here, a curvature R may be formed in a portion in which the first and second members 210 and 220 are connected to each other.

Here, a principle in which the vibration generating device 10 according to an exemplary embodiment of the present disclosure has a decreased size while maintaining a resonant frequency will be briefly described with reference to Expressions 1 and 2.

$$\begin{matrix}K ∝ \frac{1}{{L}^{3}} & 〈 Expression 1 〉 \\ ω = \sqrt{\frac{K}{m}} & 〈 Expression 2 〉\end{matrix}$$

Here, ‘K’ means a proportional factor, ‘L’ means a length of the vibrating member, ‘m’ means amass of the vibrating member, and ‘ω’ means a resonant frequency.

Referring to Expressions 1 and 2, the resonant frequency may be increased as the length of the vibrating member becomes short and be decreased as the length of the vibrating member becomes long.

Therefore, when the length of the vibrating member is decreased in order to miniaturize the vibration generating device, the resonant frequency may be increased, such that it maybe difficult for the vibration generating device to perform its function.

However, the vibration generating device 10 according to an exemplary embodiment of the present disclosure may include the vibrating member 200 that is bent, thereby decreasing an overall size of the vibration generating device 10 while maintaining an entire length of the vibrating member 200.

Meanwhile, the second member 220 may be extended vertically from the other end of the first member 210 and be bent at least four times. Next, an example in which the second member 220 is bent four times will be described.

The second member 220 may include a first bent part 221 extended in the direction upward from the first member 210, a second bent part 222 extended from an end of the first bent part 221 toward one end of the first member 210, a third bent part 223 extended from an end of the second bent part 222 toward a direction upward from the second bent part 222, a fourth bent part 224 extended from an end of the third bent part 223 toward the other end of the first member 210, and a fifth bent part 225 extended from an end of the fourth bent part 224 in a direction upward from the fourth bent part 224.

Here, curvatures R may be formed in portions in which the first to fifth bent parts 221 to 225 are connected to each other, and the second and fourth bent parts 222 and 224 may be disposed in parallel with each other.

In addition, the second bent part 222 may be disposed in parallel with the first member 210 facing the second bent part 222, and the fourth bent part 224 may be disposed in parallel with the third member 230 facing the fourth bent part 224.

In addition, the first to fifth bent parts 221 to 225 may be provided with dampers 240 preventing collision at the time of driving the vibration generating device 10.

The third member 230 may be extended from the end of the second member 220 toward one end of the first member 210, and a curvature R may be formed in a portion in which the second and third members 220 and 230 are connected to each other.

In addition, the third member 230 may be extended vertically from the end of the second member 220.

Further, the third member 230 may have the weight body 300 coupled to one surface thereof. Here, although only a configuration in which the weight body 300 is provided on one surface of the third member 230 facing the first member 210 has been shown in the accompanying drawings, the present disclosure is not limited thereto. That is, the weight body 300 may also be provided on the other surface of the third member 230 that does not face the first member 210.

In addition, the third member 230 may be provided with coupling protrusions 232 protruding and bent from outer side surfaces thereof to support the weight body 300.

The coupling protrusions 232, which support side portions of the weight body 300, may be bent upwardly or downwardly depending on a direction in which the weight body 300 is provided.

As described below, outer side surfaces of the weight body 300 facing the coupling protrusions 232 may be provided with insertion grooves 310 into which the coupling protrusions 232 may be inserted, and the coupling protrusions 232 may be inserted into and coupled to the insertion grooves 310.

In addition, the third member 230 and the weight body 300 may be coupled to each other by welding or bonding using an adhesive and be coupled to each other through only mechanical coupling between the coupling protrusion 232 and the insertion grooves 310.

In addition, a portion of the third member 230 may be disposed above the support member 121 to be overlapped with the support member 121.

The vibrating member 200 may be provided with at least one auxiliary elastic deformation slit 250 decreasing strength of the vibrating member 200 to be easily elastically deformed.

That is, the auxiliary elastic deformation slit 250 may decrease the strength of the vibrating member 200 to facilitate the elastic deformation of the vibrating member 200 at the time of driving the vibration generating device 10.

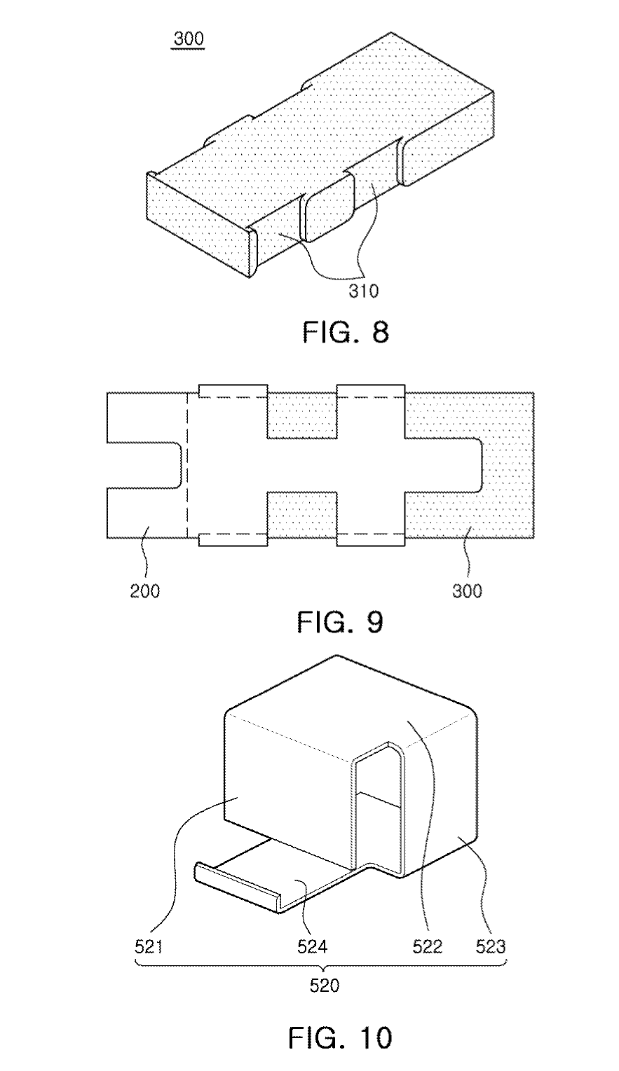

FIG. 8 is a perspective view of a weight body according to an exemplary embodiment of the present disclosure; and FIG. 9 is a plan view showing a form in which the weight body and the vibrating member according to an exemplary embodiment of the present disclosure are coupled to each other.

Referring to FIGS. 8 and 9, the weight body 300 may be provided at one side of the vibrating member 200, and may vibrate together with the vibrating member 200 at the time of vibration of the vibrating member 200 to serve to increase a vibration amount of the vibrating member 200.

Here, the weight body 300 may be provided at various positions of the vibrating member 200. Next, an example in which the weight body 300 is provided on the third member 230 of the vibrating member 200 will be described.

The weight body 300 may be coupled to the third member 230 by welding, bonding using an adhesive, or mechanical coupling.

The outer side surfaces of the weight body 300 may be provided with the insertion grooves 310 as described above, and the coupling protrusion 232 provided on the third member 230 may be inserted into the insertion grooves 310.

Therefore, the weight body 300 may be more stably fixed to the third member.

In addition, the weight body 300 may be provided with a damper preventing collision between the weight body 300 and the housing 100.

Meanwhile, in the vibration generating device 10, the weight body 300 may be an important component determining the resonant frequency of the vibration generating device 10.

Therefore, in the vibration generating device 10 according to an exemplary embodiment of the present disclosure, the additional weight member may be coupled to the weight body 300 after the vibration generating device 10 is manufactured, whereby the resonant frequency of the vibration generating device 10 may be adjusted.

Again referring to FIG. 4, the piezoelectric element 400 may be provided on one surface of the first member 210 facing the housing 100 or the other surface of the first member 210 and be warpage-deformed by an electrical signal transferred from the driving element 520a to vibrate the vibrating member 200.

Therefore, the piezoelectric element 400 may have one side connected to the board 500 in order to receive the electrical signal from the driving element 520a.

Here, positions and the number of piezoelectric elements 400 may be variously modified. That is, the piezoelectric element may be provided on at least one of the first to third members.

Here, at least a portion of the weight body 300 may be positioned above the piezoelectric element 400, and the center of the piezoelectric element 400 may be disposed to be biased toward the free end 217 of the first member 210.

The piezoelectric element 400 may be formed of polymer or lead zirconate titanate (PZT). However, the present disclosure is not limited thereto. That is, the piezoelectric element 400 may be formed of various materials as long as it may vibrate the vibrating member 200.

Meanwhile, the first member 210 may be provided with a coupling groove 211 on and to which the piezoelectric element 400 is seated and coupled, wherein the coupling groove 211 may be recessed from one side of the first member 210 to correspond to an appearance of the piezoelectric element 400.

The board 500 may be provided to enclose a portion of outer surfaces of the housing 100, have at least one driving element 520a mounted thereon in order to supply the voltage to the piezoelectric element 400, and have one side disposed in the internal space of the housing 100 to thereby be electrically and physically connected to the piezoelectric element 400.

That is, the board 500 may include a first board 510 having one side connected to the piezoelectric element 400 to thereby be disposed in the internal space of the housing 100 and the other side exposed to the outside and the second board electrically connected to the first board 510 and provided to enclose a portion of the outer surfaces of the housing 100.

The board 500 may have the at least one driving element 520a mounted thereon. To this end, mounting electrodes (not shown), wiring patterns electrically connecting between the mounting electrodes, a ground electrode, and the like, may be formed on the board 500.

In addition, the board 500 may be a printed circuit board (PCB) or a flexible PCB (FPCB) formed of polyethyleneterephthalate (PET), glass, polycarbonate (PC), silicon (Si), or the like, and may have a film form.

However, the board 500 is not limited thereto. That is, various kinds of members to which the driving element 520a may be coupled may be used as the board 500.

In addition, the board 500 may include conductive vias (not shown) electrically connecting the mounting electrodes and circuit patterns formed in the board to each other, and may have a cavity formed therein so that an electronic component may be mounted therein.

The first board 510 may include a housing coupling part 511 contacting the housing 100, more specifically, the lower case 120, a piezoelectric element coupling part 513 connected to the piezoelectric element 400, and a connecting part 512 connecting the housing coupling part 511 and the piezoelectric element coupling part 513 to each other.

Here, the connecting part 512 may have elasticity. Therefore, the first board 510 may be maintained in a state in which it is coupled to both of the housing 100 and the piezoelectric element 400, and the piezoelectric element coupling part 513 may vibrate together with the vibration generating device 10 at the time of vibration of the vibration generating device 10.

Next, a configuration of the second board 520 will be described with reference to FIG. 10.

The second board 520 may have a first surface 521 on which the at least one driving element 520a is mounted to apply the voltage to the piezoelectric element 400, a second surface 522 extended from the first surface 521 to cover an upper surface of the housing 100, a third surface 523 extended from the second surface to cover a side surface of the housing 100, and a fourth surface 524 extended from the third surface to cover a lower surface of the housing 100.

Here, it is to be noted that the second board 520 has been partitioned into each section using separate reference numerals for convenience of explanation and the first to fourth surfaces may be formed as a continuous single member.

The first surface 521 may have the driving element 521a mounted thereon in order to apply the voltage to the piezoelectric element 400.

Since the vibration generating device 10 vibrates by the piezoelectric element 400, which is controlled by the electrical signal, the at least one driving element 521a for driving the piezoelectric element 400 may be mounted on the first surface 521.

The second and third surfaces 522 and 532 may be extended from the first and second surfaces 521 and 522, respectively, to enclose the upper surface and the side surface of the housing, respectively, and the fourth surface 524 may be extended to enclose the lower surface of the housing 100.

As a result, the second to fourth surfaces may be provided to enclose the outer surfaces of the housing, and the second board 520 may be coupled to the outer surface of the housing.

Here, one end of the fourth surface 524 may be bent upwardly.

This may be to fix a position of the second board 520 at the time of coupling the second board 520 and the housing 100 to each other. That is, the second board 520 may be inserted into and coupled to the housing 100, and in the case in which one end of the fourth surface 524 is not bent, the second board 520 may pass through the housing 100.

Therefore, one end of the fourth surface 524 may be bent to allow the second board 520 to be coupled to a predetermined position.

Meanwhile, the first and second boards 510 and 520 may be electrically connected to each other. For example, the first and second boards 510 and 520 may be electrically connected to each other through a connection terminal, a lead wire, or the like.

As a result, the vibration generating device 10 according to an exemplary embodiment of the present disclosure may include the driving element 520a formed integrally with the housing 100 on the outer surface of the housing 100, whereby a volume occupied by a separate driving circuit part may be significantly decreased.

The protective cap 130 may be provided in order to protect the driving element 520a mounted on the board 500 and be provided to cover one side of the housing 100 at which the board 500, more specifically, the second board 520 is provided.

That is, as described above, the board 500 may be coupled to the outer surfaces of the housing 100, and may have the at least one driving element 520a mounted thereon in order to drive the vibration generating device 10.

Here, the driving element 520a may be exposed to the outside. Therefore, there may be a risk that the driving element 520a will be damaged due to external impact or foreign materials will be introduced into the driving element 520a.

That is, the protective cap 130 may be provided on the housing 100 to enclose the outer surface of the driving element 520a to protect the driving element 520a.

As set forth above, with the vibration generating device according to exemplary embodiments of the present disclosure, sizes of the vibration generating device and the driving circuit may be significantly decreased.

In addition, with the vibration generating device according to exemplary embodiments of the present disclosure, an overall size of the vibration generating device may be significantly decreased while maintaining the resonant frequency.

While exemplary embodiments have been shown and described above, it will be apparent to those skilled in the art that modifications and variations could be made without departing from the scope of the present invention as defined by the appended claims.

What is claimed is:

1. A vibration generating device comprising:
a housing having an internal space;
a vibrating member provided in the internal space to vibrate;
a piezoelectric element coupled to one surface of the vibrating member; and
a board which is provided to enclose a portion of outer surfaces of the housing, on which at least one driving element is mounted in order to supply a voltage to the piezoelectric element, and of which one side is disposed in the internal space to be connected to the piezoelectric element.

2. The vibration generating device of claim 1, wherein the board includes:
a first board disposed in the internal space and connected to the piezoelectric element; and
a second board electrically connected to the first board and provided to enclose a portion of the outer surfaces of the housing, and
the driving element is provided on the second substrate.

3. The vibration generating device of claim 2, wherein the second board has a first surface on which the at least one driving element is mounted, a second surface extended from the first surface to cover an upper surface of the housing, a third surface extended from the second surface to cover a side surface of the housing, and a fourth surface extended from the third surface to cover a lower surface of the housing.

4. The vibration generating device of claim 3, wherein one end of the fourth surface is bent upwardly.

5. The vibration generating device of claim 1, wherein one side of the housing is provided with a protective cap disposed to enclose an outer surface of the driving element.

6. The vibration generating device of claim 1, further comprising a weight body coupled to the vibrating member.

7. The vibration generating device of claim 1, wherein the vibrating member includes:
a first member having a fixed end fixed to the housing and a free end extended from the fixed end to thereby vibrate;
a second member extended from the free end of the first member in a direction upward from the first member; and
a third member extended from an end of the second member toward the fixed end of the first member.

8. The vibration generating device of claim 7, wherein the second member is bent at least four times.

9. The vibration generating device of claim 7, wherein the second member is extended vertically in the direction upward from the first member, and
the third member is extended vertically from the end of the second member.

10. The vibration generating device of claim 1, wherein the vibrating member includes a coupling groove which is recessed from one surface thereof so that the piezoelectric element is seated thereon and coupled thereto.

11. The vibration generating device of claim 1, wherein the vibrating member is provided with at least one auxiliary elastic deformation slit adjusting strength of the vibrating member.

12. A vibration generating device comprising:
a housing;
a vibrating member including a first member having one end which is fixed to the housing to be a fixed end and the other end which is a free end, a second member which is bent at least two or more times and extended from the other end of the first member in a direction upward from the first member, and a third member which is extended from an end of the second member toward one end of the first member.;
a weight body provided on the vibrating member;
a piezoelectric element provided on one surface of the vibrating member; and
a board which is provided to enclose a portion of outer surfaces of the housing and on which at least one driving element is mounted in order to supply a voltage to the piezoelectric element.
